(19) United States
(12) Patent Application Publication
(10) Pub. No.: US 2010/0006748 A1
(43) Pub. Date: Jan. 14, 2010

(54) ENCODER AND PHOTODETECTOR FOR ENCODER

(75) Inventors: Seiichiro Mizuno, Shizuoka (JP); Yoshitaka Terada, Shizuoka (JP); Hitoshi Inoue, Shizuoka (JP)

Correspondence Address: DRINKER BIDDLE & REATH (DC), 1500 K STREET, N.W., SUITE 1100, WASHINGTON, DC, 20005-1209, US

(73) Assignee: HAMAMATSU PHOTONICS K.K., Hamamatsu-shi (JP)

(21) Appl. No.: 12/444,959

(22) PCT Filed: Sep. 18, 2007
(86) PCT No.: PCT/JP2007/068045

§ 371 Date: May 20, 2009

(30) Foreign Application Priority Data
Oct. 10, 2006 (JP) 2006-276629

(51) Int. Cl. H01J 40/02

(52) U.S. Cl. 250/236; 250/200

(57) ABSTRACT

An encoder includes a first rotating body and a second rotating body which have slits formed therein and rotate interlockingly with each other; a light source device which emits to-be-detected light to the slits; and a photodetecting device which includes a first scale and a second scale having a plurality of photodetectors aligned along annular alignment lines, and an output part which outputs output signals based on light intensities of the to-be-detected light made incident on the photodetectors of the first scale and the second scale through the slit. The rotation ratio of the second rotating body is different from that of the first rotating body, and to the photodetectors, attributes are assigned every predetermined phase angle.

### TECHNICAL FIELD

The present invention relates to an optical encoder and a photodetecting device for an encoder.

### BACKGROUND ART

As a conventional optical encoder, for example, there is an optical encoder described in Patent Document 1. This conventional encoder has an optical scale on which lattice windows with different diffracted patterns are disposed, and images a diffracted pattern of to-be-detected light, irradiated on a lattice window through a slit by an image sensor. Then, the lattice window is identified from the imaged diffracted pattern, and based on a position of the diffracted pattern in the image, the position of the lattice window is identified and an absolute angle of an object to be measured is detected.

Patent Document 1: Japanese Published Examined Patent Application No. H8-10145

### DISCLOSURE OF THE INVENTION

### Problem to be Solved by the Invention

In such a type of encoder, preferably, the detectable range of absolute angles (angle detection range) of objects to be measured is as wide as possible. However, in the above-described conventional optical encoder, the scale must be provided with a plurality of lattice windows with different diffracted patterns. Accuracies of the diffracted patterns influence the resolution of angle detection, so that high processing accuracies are required when providing the diffracted patterns on the scale.

The present invention was made for solving the above-described problem, and an object thereof is to provide an encoder which can widen an angle detection range without requiring complicated processing, and a photodetecting device for an encoder to be used for such an encoder.

### Means for Solving the Problems

To solve the above-described problem, an encoder of the present invention includes: a first rotating body and a second rotating body which rotate interlockingly with each other, wherein a slit is formed in each of the first rotating body and the second rotating body; a light source device which emits to-be-detected light to the slit; and a photodetecting device which includes a first scale and a second scale, whrein each of the first scale and the second scale has a plurality of photodetectors aligned along an annular alignment line, the photodetecting device including an output part which outputs output signals based on light intensities of the to-be-detected light, made incident on the photodetectors of the first scale and the second scale through the slit, wherein a rotation ratio of the second rotating body is different from a rotation ratio of the first rotating body, and attributes are assigned to the photodetectors every predetermined phase angle.

In this encoder, the rotation ratio of the second rotating body is different from that of the first rotating body, and attributes are assigned to the photodetectors every predetermined angle. Therefore, along with changes in rotation angle of the first rotating body, a combination of an attribute of the photodetector corresponding to the peak position of the light intensity of to-be-detected light, detected by the first scale and an attribute of the photodetector corresponding to the peak position of the light intensity of the to-be-detected light, detected by the second scale changes sequentially. Therefore, in this encoder, a periodic number of the first rotating body can be identified based on the combination of regions, so that the angle detection range on the first scale can be widened to not less than 360 degrees. In this encoder, there is no need to provide a plurality of lattice windows with different diffracted patterns on the scales as in the conventional case, so that complicated processing is also not necessary.

Preferably, the to-be-detected light which passed through the slit crosses the alignment line at least at two points apart from each other. In this case, when either one point of the points at which the output signal peaks is regulated as a reference point to calculate an absolute angle, a relative angle (reference relative angle) between the reference point and the other point can be grasped in advance from the shape of the slit. Therefore, even when the position of the slit deviates from the scale, the deviation of the relative angle is calculated as a correction amount, and by adding or subtracting the correction amount to and from an absolute angle shown by the reference point, an absolute angle can be accurately detected.

Preferably, the photodetectors are aligned in a staggered pattern along the alignment line. In this case, the angle detection resolution can be improved while the scale is maintained small in size.

The photodetecting device for an encoder of the present invention includes a first scale and a second scale, wherein each of the first scale and the second scale has a plurality of photodetectors aligned along an annular alignment line, and an output part which outputs output signals based on light intensities of to-be-detected light, the light made incident on the photodetectors of the first scale and the second scale, wherein attributes are assigned to the photodetectors every predetermined phase angle.

In this photodetecting device for an encoder, by interposing the first rotating body and the second rotating body which are different in rotation ratio from each other and have slits between the photodetecting device and a light source device, along with rotation angle changes of the first rotating body, a combination of an attribute of the photodetector corresponding to a peak position of the light intensity of the to-be-detected light, detected by the first scale and an attribute of the photodetector corresponding to a peak position of the light intensity of the to-be-detected light, detected by the second scale can be changed sequentially. Therefore, in this photodetecting device for an encoder, a periodic number of the first rotating body can be identified based on the combination of regions, so that the angle detection range on the first scale can be widened to not less than 360 degrees. In this photodetecting device for an encoder, there is no need to provide a plurality of lattice windows with different diffracted patterns on the scale as in the conventional case, so that complicated processing is also not necessary.

The output part has a shift register which sequentially outputs output signals from the photodetectors, and the shift register is preferably arranged at the inner side of the alignment line. By arranging the shift register in an extra space at the inner side of the alignment line, the scale can be reduced in size.

Preferably, the photodetectors are aligned in a staggered pattern along the alignment line. In this case, the angle detection resolution can be improved while the scale is maintained small in size.

### Effect of the Invention

According to an encoder and a photodetecting device for an encoder of the present invention, the angle detection range can be widened without requiring complicated processing.

### BRIEF DESCRIPTION OF THE DRAWINGS

FIG. 1 is a perspective view showing an embodiment of an encoder of the present invention;

FIG. 2 is a front view of a geared slit plate;

FIG. 3 is a front view of a photodetecting device;

FIG. 4 is a front view showing attributes of PDs

FIG. 5 is a view showing an arrangement relationship of a slit and a scale;

FIG. 6 is a flowchart showing processing for detecting by the encoder shown in FIG. 1 an absolute angle of an object to be measured;

FIG. 7 is a view showing one-dimensional profiles of the light intensities of to-be-detected light;

FIG. 8 is a view showing a state when the one-dimensional profiles shown in FIG. 7 are binarized;

FIG. 9 is a view showing an arrangement relationship between a slit and a scale when positional deviation occurs;

FIG. 10 is a view showing a one-dimensional profile of light intensity of to-be-detected light when positional deviation occurs;

FIG. 11 is a view showing combinations of attributes appearing in the encoder shown in FIG. 1;

FIG. 12 is a view showing combinations of attributes appearing when the phase of a geared slit plate goes ahead;

FIG. 13 is a view showing combinations of attributes appearing when the phase of a geared slit plate delays;

FIG. 14 is a view of a table of attribute combination changes;

FIG. 15 is a perspective view showing an encoder of a modified example; and

FIG. 16 is a perspective view showing an encoder of another modified example.

### DESCRIPTION OF SYMBOLS

1: encoder,

11: LED (light source device),

12A, 12B: photodetecting device,

13A, 13B: geared slit plate (first rotating body, second rotating body),

15A, 15B: slit,

16: PD (photodetector),

17A, 17B: scale plate (first scale, second scale),

18: output part,

19: shift register,

L1: first alignment line,

L2: second alignment line.

### BEST MODES FOR CARRYING OUT THE INVENTION

Hereinafter, a preferred embodiment of an encoder and a photodetecting device for an encoder of the present invention will be described in detail with reference to the drawings.

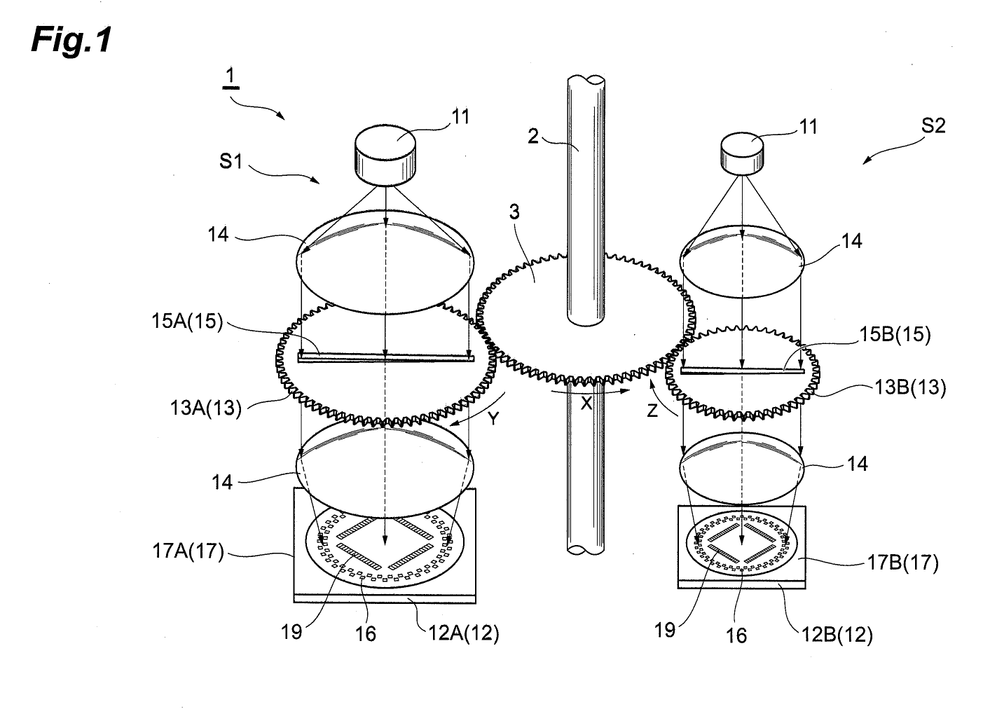

FIG. 1 is a perspective view showing an embodiment of an encoder of the present invention. The encoder 1 shown in FIG. 1 is a so-called absolute type rotary encoder, and is, for example, a device for detecting an absolute angle of an object to be measured (not shown) such as a steering wheel of an automobile. This encoder 1 includes a rotation shaft 2 to be joined to an object to be measured, a geared disc 3 fixed to the rotation shaft 2, and two optical systems S1 and S2 disposed apart from each other in proximity to the geared disc 3. The geared disc 3 rotates in, for example, the arrow X direction along with rotation of the rotation shaft 2 interlocked with an object to be measured.

Each of the optical system S1 and the optical system S2 includes an LED (light source device) 11 as a point light source which emits to-be-detected light, a photodetecting device (photodetecting device for an encoder) 12 (12A, 12B) which is disposed so as to be opposed to the LED and photodetects to-be-detected light, a geared slit plate (rotating body) 13 (13A, 13B) which engages with the geared disc 3, and a pair of parallel pencil forming lenses 14 and 14 disposed so as to sandwich the geared slit plate 13.

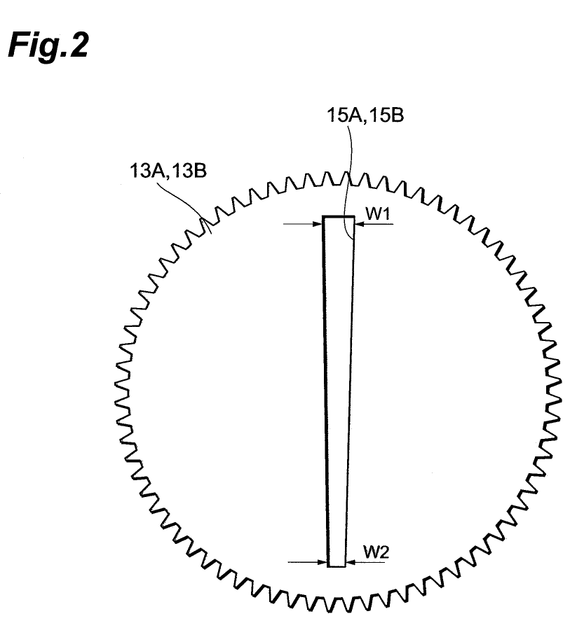

The geared slit plates 13A and 13B have slits 15 (15A and 15B) which allow a part of to-be-detected light emitted from the LED 11 to pass through, respectively, as shown in FIG. 2. The slits 15A and 15B are formed like a straight line so as to pass through the centers of the geared slit plates 13. The slits 15A and 15B are formed so that the slit widths become smaller gradually from one end side toward the other end side, and the slit width W1 on one end side is approximately twice as large as the slit width W2 on the other end side.

As shown in FIG. 1, the geared slit plates 13A and 13B rotate interlockingly with each other along with rotation of the geared disc 3, however, the rotation ratio of the geared slit plate 13B is different from that of the geared slit plate 13A. In more detail, the rotation ratio of the geared disc 3 to the geared slit plate 13A is 1 to 1, and on the other hand, the rotation ratio of the geared slit plates 13A and 13B is 6 to 10. Therefore, when the geared disc 3 rotates by 360 degrees in the arrow X direction, the geared slit plate 13A rotates by 360 degrees in the arrow Y direction, and the geared slit plate 13B rotates by 5/3 revolution in the arrow Z direction.

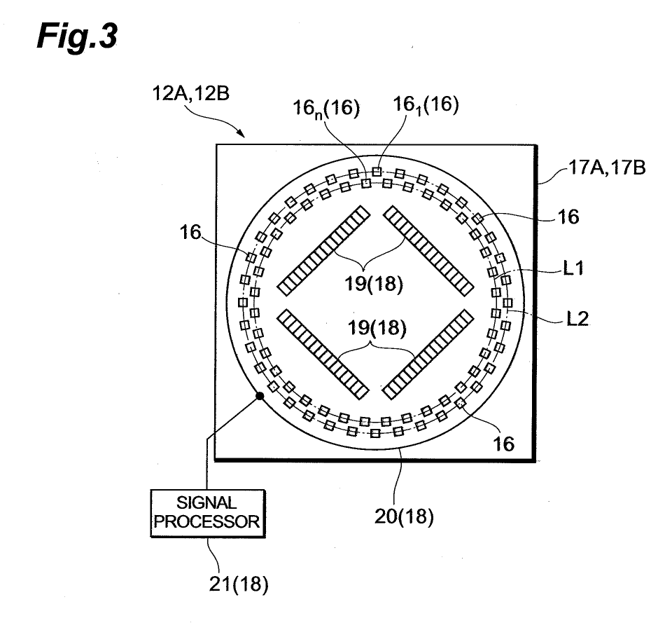

The photodetecting device 12A, 12B includes a scale plate 17 (17A, 17B) having a plurality of PDs (photodetectors) 16 aligned as shown in FIG. 3, and an output part 18 which outputs signals from the respective PDs 16. On the scale plate 17A and the scale plate 17B, a first alignment line L1 and a second alignment line L2 with diameters corresponding to the lengths of the slits 15A and 15B of the geared slit plates 13A and 13B are set concentrically, respectively, and the PDs 16 are arranged annularly in a staggered pattern on each of the alignment lines L1 and L2.

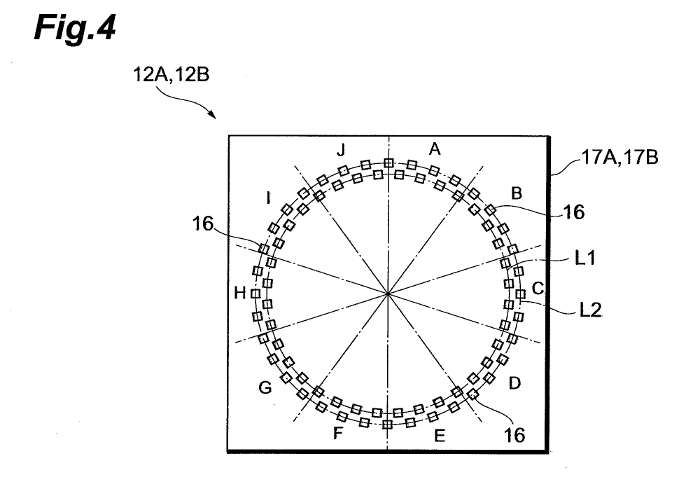

To the PDs 16 from the first PD 16₁ (0 degrees) to the final PD 16ₙ (359.5 degrees), angle information is assigned clockwise in increments of, for example, 0.5 degrees. To the PDs 16, ten attributes A to J are assigned every phase angle of 36 degrees as shown in FIG. 4, respectively. To each PD 16, attribute identification information showing which region the corresponding PD 16 belongs to is assigned.

The output part 18 includes a plurality (four in the present embodiment) of shift registers 19, a video line 20, and a signal processor 21. The shift registers 19 are arranged in a substantially rectangular form concentrically with the scale plate 17 at the inner side of each alignment line L1, L2, and supply the respective PDs 16 with scanning signals for outputting output signals based on the light intensities of photodetected to-be-detected light and attribute identification signals including attribute identification information. The video line 20 is disposed concentrically with and at the outer side of each alignment line L1, L2, and outputs the output signals and attribute identification signals from the respective PDs 16 to the signal processor 21. The signal processor 21 outputs the output signals and attribute identification signals received from the respective PDs 16 via the video line 20 to the outside. The supply lines (not shown) for supplying drive signals to each shift register 19 are connected between, for example, the PD 16₁ and the PD 16ₙ.

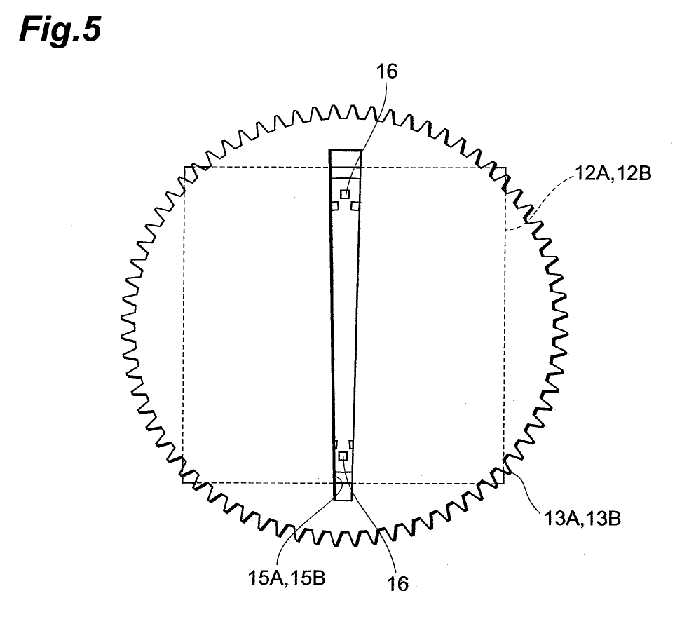

In this encoder 1, in the optical system S1 and the optical system S2, when to-be-detected light is emitted from the LED 11 as a spot light source, the to-be-detected light is converted into a parallel pencil by a parallel pencil forming lens 14, and made incident on the geared slit 13A, 13B, respectively. The to-be-detected light formed like a straight line by passing through the slit 15A, 15B is converged by the parallel pencil forming lens 14, and as shown in FIG. 5, at two points of one end side and the other end side having different slit widths from each other, crosses each alignment line L1, L2 of the scale plate 17A, 17B, and is made incident on the respective PDs 16 through the slit 15A, 15B. From the PDs 16, output signals based on the light intensities of the photodetected to-be-detected light and attribute identification signals are output, respectively, and are output from the signal processor 21 to the outside.

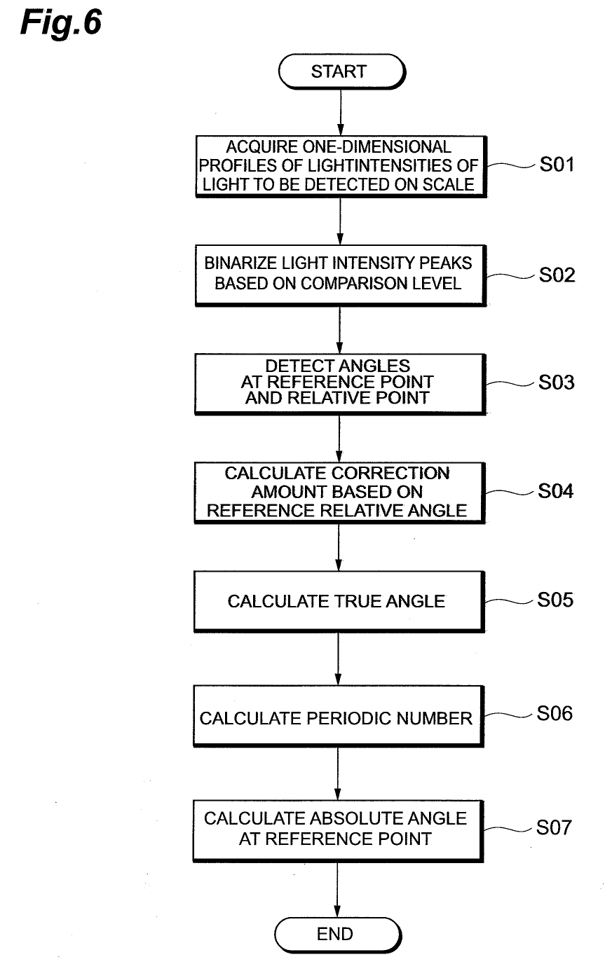

Subsequently, processing for detecting by the encoder 1 configured as described above, an absolute angle of an object to be measured will be described with reference to the flowchart of FIG. 6. The series of control processing shown below is executed by a computing means such as a personal computer, etc., which is connected to, for example, the encoder 1.

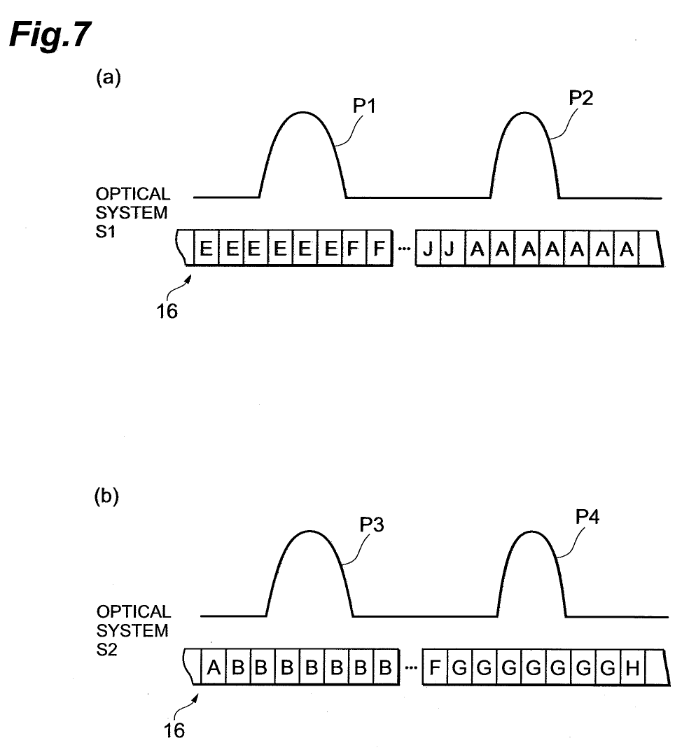

First, output signals and attribute identification signals obtained from the PDs 16 of the scale plates 17A and 17B are collected from the signal processors 21, respectively. Then, one-dimensional profiles of the light intensities of to-be-detected light with respect to the respective PDs 16 are obtained (Step S01). At this time, the to-be-detected light which passed through the slits 15A and 15B like straight lines are made incident on two of the PDs 16 aligned annularly, so that when the one-dimensional profiles of the PDs 16 of the scale plates 17A and 17B are analyzed, as shown in FIG. 7, the light intensity peaks P1 and P2 and the light intensity peaks P3 and P4 apart from each other are obtained, respectively.

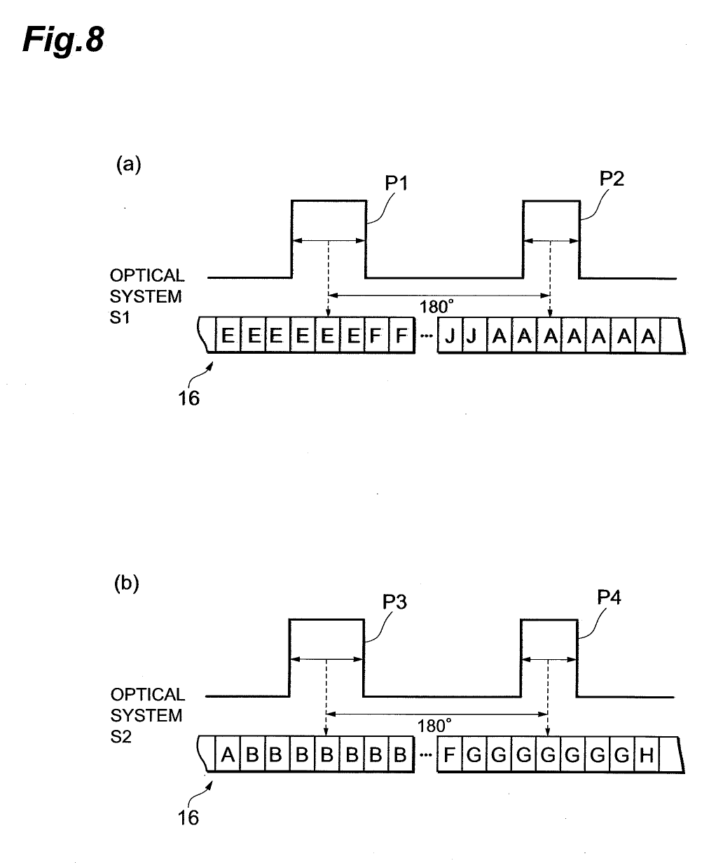

In the encoder 1, the slit width W1 on one end side is approximately twice as large as the slit width W2 on the other end side, so that the half width of the light intensity peak P1, P3 is approximately twice as large as the half width of the light intensity peak P2, P4. Therefore, the light intensity peaks P1 and P2 and the light intensity peaks P3 and P4 can be easily identified. Based on a predetermined comparison level, as shown in FIG. 8, the obtained light intensity peaks P1 and P2 and light intensity peaks P3 and P4 are binarized (Step S02).

After binarization, first, an angle based on the light intensity peaks P1 and P2 obtained from the one-dimensional profile of each PD 16 on the scale plate 17A is calculated. In this case, the PD 16 corresponding to the half center of the light intensity peak P1 is set as a reference point for determining an absolute angle, and the PD 16 corresponding to the half center of the light intensity peak P2 is set as a relative point for determining a relative angle between the light intensity peaks P1 and P2. Then, based on the angle information assigned to each PD 16, angles of the reference point and the relative point are detected (Step S03).

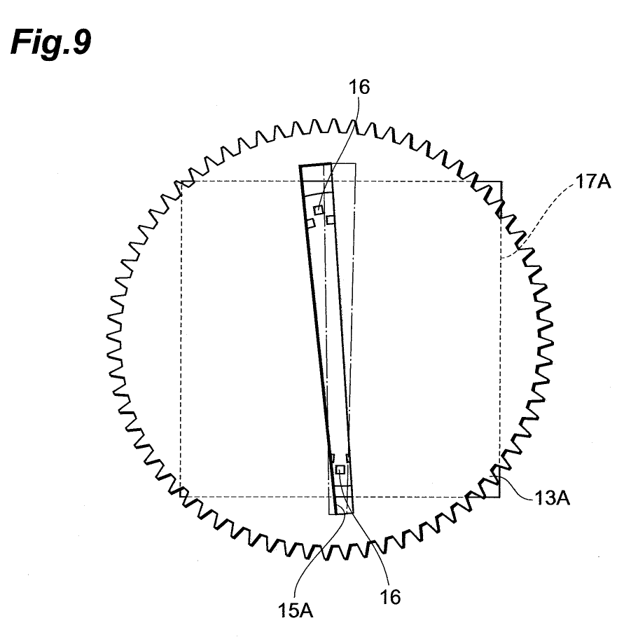

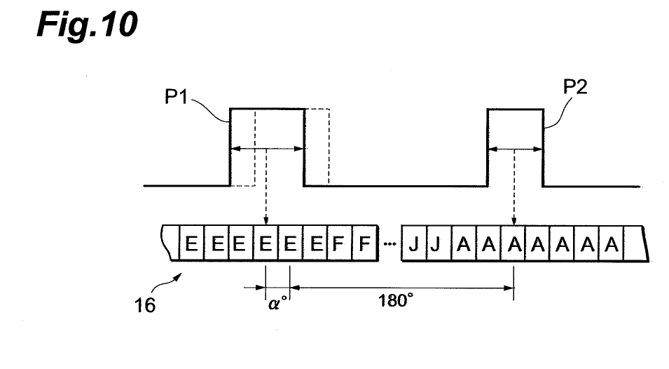

Here, in the encoder 1, the slit 15A is formed like a straight line. Therefore, when the position of the slit 15A does not deviate from the scale plate 17A, the relative angle between the reference point and the relative point (hereinafter, referred to as “reference relative angle”) is calculated as 180 degrees unambiguously. On the other hand, as shown in FIG. 9, when the position of the slit 15A deviates from the scale plate 17A due to the axial deviation and rotational deviation of the geared slit plate 13A, 13B, etc., as shown in FIG. 10, for example, the position of the reference point deviates from a true angle by α degrees. Therefore, the relative angle between the reference point and the relative point at the time of detection is calculated as 180 degrees+α degrees. Therefore, when a difference of α degrees occurs between the reference relative angle and the relative angle at the time of detection, the α degrees is calculated as an angle deviation correction amount (Step S04). Then, by adding (or subtracting) the correction amount of α degrees to the angle of the reference point detected at Step S03, the true angle from which the influence of the angle deviation is removed is calculated (Step S05).

After the true angle is calculated, a periodic number of the geared slit plate 13A is calculated (Step S06). To calculate the periodic number, first, attributes of the PDs 16 corresponding to the true angles calculated from the respective one-dimensional profiles of the scale plates 17A and 17B are identified. Here, the rotation ratio of the geared slit plates 13A and 13B is 6 to 10 in the encoder 1, so that along with the rotation of the geared slit plate 13A, the combination of attributes of PDs 16 corresponding to the true angles calculated from the respective one-dimensional profiles of the scale plates 17A and 17B gradually changes over three periods.

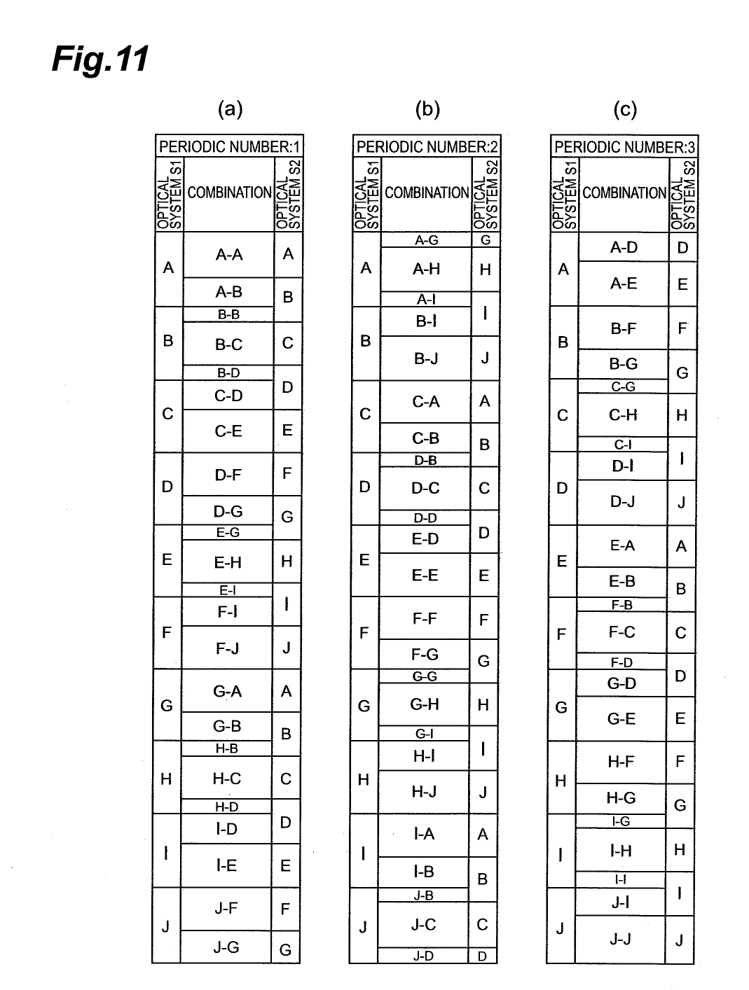

FIG. 11 is a view showing attribute combination changes. As shown in FIG. 11, when the periodic number of the geared slit plate 13A is 1, the attribute combination is any of 23 patterns in total of A-A, A-B, B-B, B-C, B-D, C-D, C-E, D-F, D-G, E-G, E-H, E-I, F-I, F-J, G-A, G-B, H-B, H-C, H-D, I-D, I-E, J-F, and J-G. When the periodic number of the geared slit plate 13A is 2, the attribute combination is any of 24 patterns in total of A-C, A-H, A-I, B-I, B-J, C-A, C-B, D-B, D-C, D-D, E-D, E-E, F-F, F-G, G-G, G-H, G-I, H-I, H-J, I-A, I-B, J-B, J-C, and J-D. When the periodic number of the geared slit plate 13A is 3, the attribute combination is any of 23 patterns in total of A-D, A-E, B-F, B-G, C-G, C-H, C-I, D-I, D-J, E-A, E-B, F-B, F-C, F-D, G-D, G-E, H-F, H-G, I-G, I-H, I-I, J-I, and J-J. When the geared slit plate 13A rotates three times, the attribute combinations loop back.

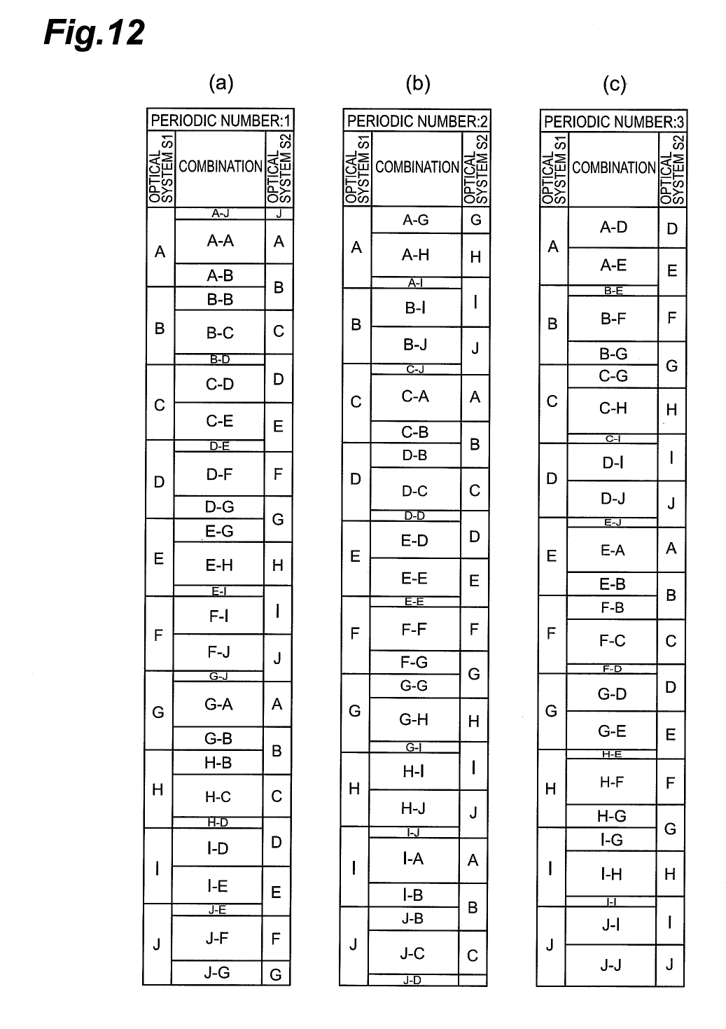

When the geared slit plate 13A, 13B rotates in reverse, backlash may occur. In consideration of this backlash, for example, in the case where the phase of the geared slit plate 13B goes forward one column (one PD) ahead of the geared slit plate 13A, as shown in FIG. 12, when the periodic number of the geared slit plate 13A is 1, four new patterns of A-J, D-E, G-J, and J-E appear. When the periodic number of the geared slit plate 13A is 2, three new patterns of C-J, F-E, and I-J appear, and when the periodic number of the geared slit plate 13A is 3, three new patterns of B-E, E-J, and H-E appear.

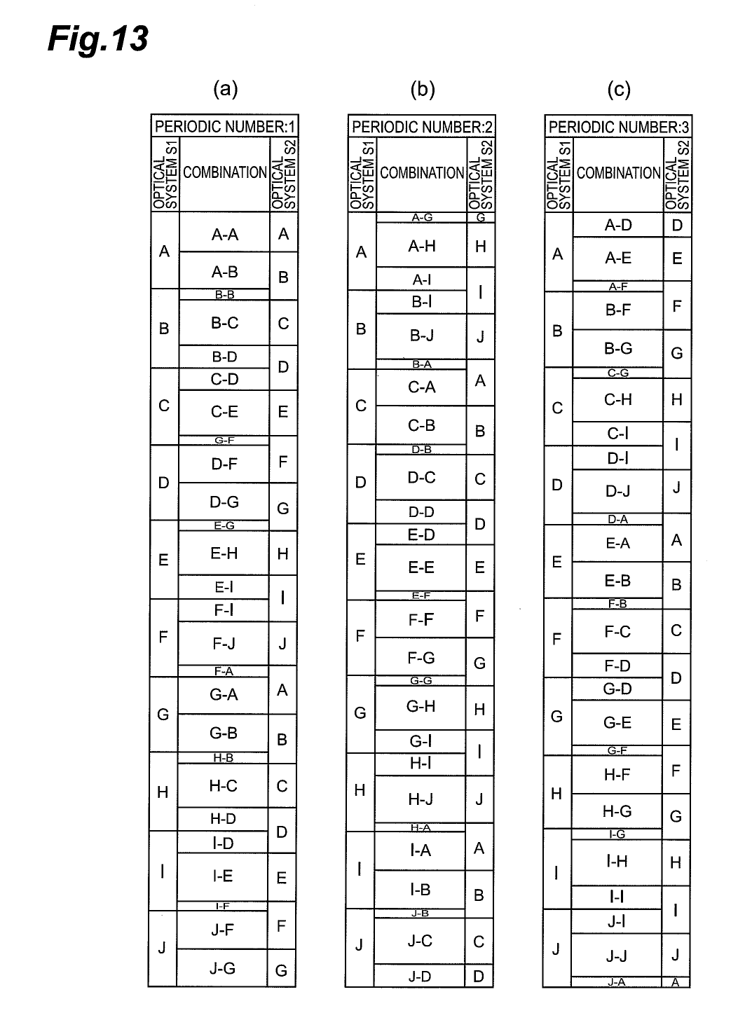

On the other hand, for example, in the case where the phase of the geared slit plate 13B delays to the negative side one column (one PD) behind the geared slit plate 13A, as shown in FIG. 13, when the periodic number of the geared slit plate 13A is 1, three new patterns of C-F, F-A, and I-F appear. When the periodic number of the geared slit plate 13A is 2, three new patterns of B-A, E-F, and H-A appear, and when the periodic number of the geared slit plate 13A is 3, four new patterns of A-F, D-A, G-F, and J-A appear.

Therefore, the attribute combination of the PDs 16 corresponding to the true angles calculated from the respective one-dimensional profiles of the scale plates 17A and 17B is identified, and by checking which periodic number the combination appears at, the periodic number of the geared slit plate 13A can be calculated. Describing the case of FIG. 8 by way of example, the attribute of the PD 16 corresponding to the true angle calculated from the one dimensional profile of the scale plate 17A is E, and the attribute of the PD 16 corresponding to the true angle calculated from the one-dimensional profile of the scale plate 17B is B, so that the attribute combination is E-B. Therefore, the periodic number of the slit plate 13A is identified as 3.

After the periodic number is calculated, the absolute angle at the reference point is calculated (Step S07). When the periodic number of the slit plate is 1, the true angle obtained at Step S05 is the absolute angle of the object to be measured. When the periodic number of the geared slit plate 13A is 2, an angle obtained by adding 360 degrees to the absolute angle obtained at Step S05 is the absolute angle of the object to be measured, and when the periodic number of the geared slit plate 13A is 3, an angle obtained by adding 720 degrees to the true angle calculated at Step S05 is the absolute angle of the object to be measured.

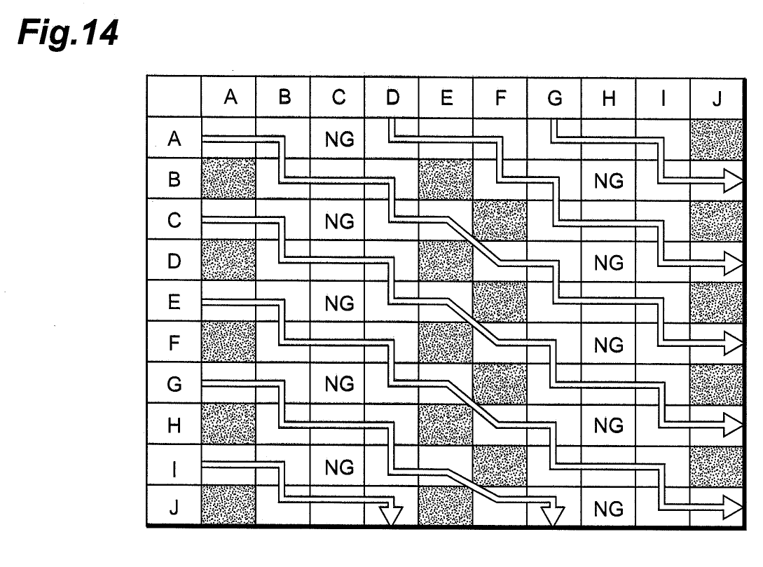

FIG. 14 is a view showing a table of attribute combination changes. As shown in FIG. 14, when the geared slit plates 13A and 13B rotate, the combination of attributes changes from A-A to J-J according to the loci shown by the arrows. The portions shown with pearskin shading are attribute combinations appearing when considering the above-described backlash. On the other hand, as shown in the drawing, a total of 10 patterns of A-C, B-H, C-C, D-H, E-C, F-H, G-C, H-H, I-C, and J-H are patterns (NG patterns) which do not appear in principle even when considering the backlash. Therefore, at Step S06, when the attribute combination of the PDs 16 corresponds to the NG pattern, for example, the generation of a mechanical failure such as breakage of the geared disc 3 and the geared slit plates 13A and 13B can be detected.

As described above, in the encoder 1, the rotation ratio of the geared slit plates 13A and 13B which rotate interlockingly with each other is 6 to 10, and attributes from A to J are assigned to the respective PDs 16 of the scale plates 17A and 17B every phase angle of 36 degrees. Accordingly, in the encoder 1, the periodic number of the geared slit plate 13A can be identified over three periods based on the combination of attributes of the PDs 16 corresponding to the true angles calculated from the respective one-dimensional profiles of the scale plates 17A and 17B, so that the angle detection range can be widened to 1080 degrees. In this encoder 1, there is no need to provide a plurality of lattice windows with different diffracted patterns on the scale as in the conventional case, so that complicated processing is also not necessary.

In the encoder 1, at two of the plurality of PDs 16 aligned annularly as a scale, to-be-detected light which passed through the straight-line-like slit 15A is detected. At this time, due to the shape of the straight-line-like slit 15A, the reference relative angle between the reference point corresponding to the light intensity peak P1 of the to-be-detected light and the relative point corresponding to the light intensity peak P2 can be unambiguously calculated as 180 degrees. Therefore, in the encoder 1, even if the position of the slit 15A deviates from the scale plate 17A, by calculating the correction amount α from the deviation between the relative angle between the reference point and the relative point at the time of angle detection and the reference relative angle, an absolute angle of an object to be measured can be accurately detected.

On the other hand, on the photodetecting device 12 side, only simple processing such as outputting of output signals based on the light intensities of to-be-detected light made incident on the respective PDs 16 to the outside is performed, so that signal processing is performed quickly. In addition, a frame memory, etc., are also not necessary, and the photodetecting device 12 is reduced in size and cost. In the photodetecting device 12, the PDs 16 are aligned in a staggered pattern on the annular alignment lines L1 and L2. Due to this arrangement of the PDs 16, the angle detection resolution can be improved while the scale plate 17 is maintained small in size. Further, the shift registers 19 are arranged in a substantially rectangular shape concentrically with the scale plate 17 at the inner side of the alignment lines L1, L2. Thus, by arranging the shift registers 19 in an extra space at the inner side of the alignment lines L1, L2, the photodetecting device 12 can be further reduced in size.

The present invention is not limited to the above-described embodiment. For example, in the above-described embodiment, the rotation ratio of the geared slit plates 13A and 13B is 6 to 10, however, it may be changed to 8 to 10 and 4 to 6, etc., according to the necessary angle detection range as appropriate. The number of attributes to be assigned to the PDs 16 can also be changed as appropriate.

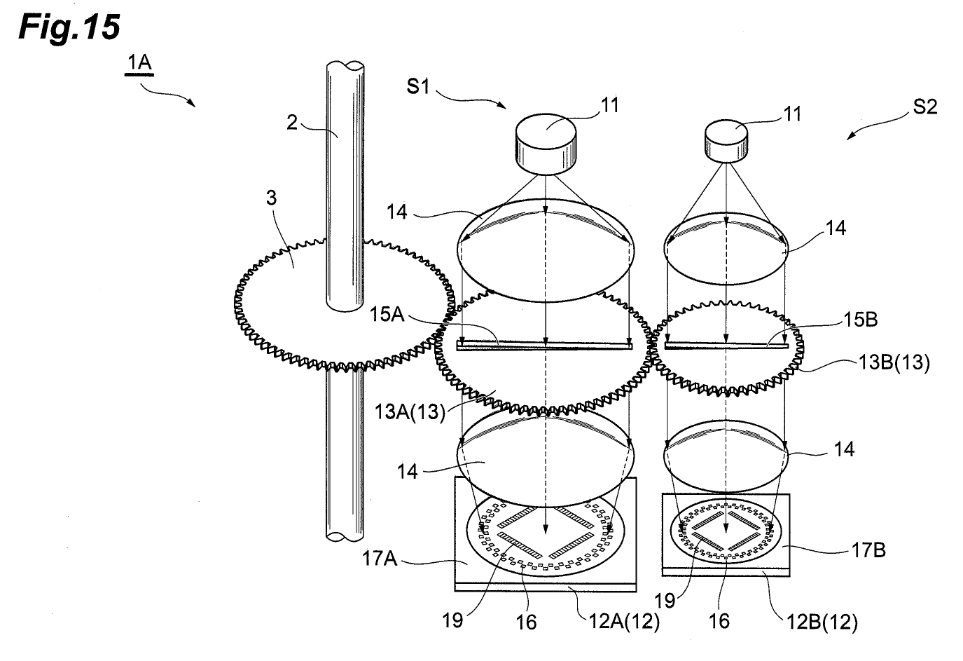

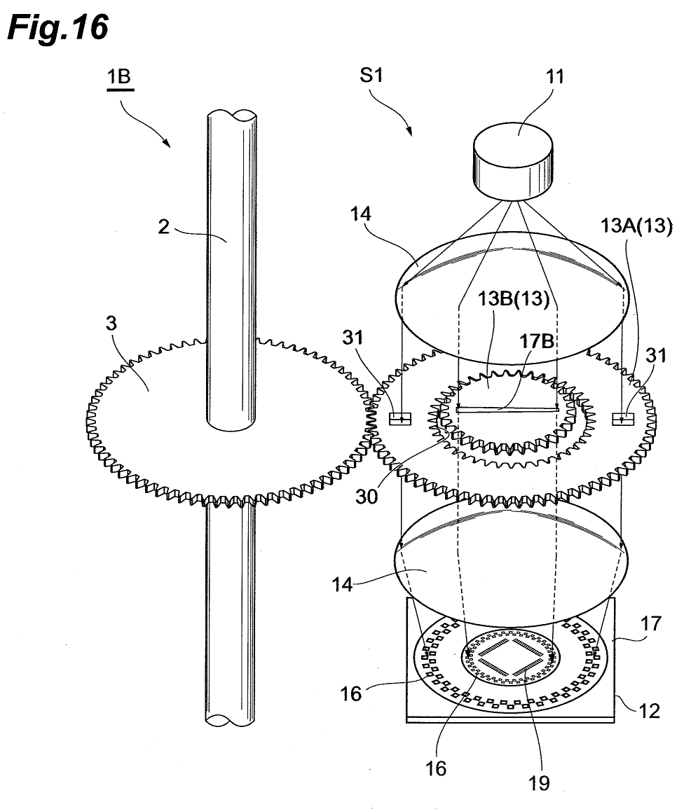

Further, in the above-described embodiment, the geared slit plates 13A and 13B are engaged with one side and the other side of the geared disc 3, respectively, however, as in the encoder 1A shown in FIG. 15, the geared slit plate 13B may be directly engaged with the geared slit plate 13A. As in the encoder 1B shown in FIG. 16, it may also be allowed that cogs 30 are formed at the inner side of the geared slit plate 13A, and with these cogs 30, the geared slit plate 13B is engaged. In this case, slits 31 separated to one end side and the other end side are formed in the geared slit plate 13A, and PDs 16 are aligned annularly so as to correspond to the lengths of the geared slit plates 13A and 13B in the photodetecting device 12. Accordingly, the optical systems can be consolidated into one, and the encoder 1 is further reduced in size.

1. An encoder comprising:
a first rotating body and a second rotating body which rotate interlockingly with each other, wherein a slit is formed in each of the first rotating body and the second rotating body;
a light source device which emits to-be-detected light to the slit; and
a photodetecting device which includes a first scale and a second scale, wherein each of the first scale and the second scale has a plurality of photodetectors aligned along an annular alignment line, the photodetecting device including an output part which outputs output signals based on light intensities of the to-be-detected light, made incident on the photodetectors of the first scale and the second scale through the slit, wherein
a rotation ratio of the second rotating body is different from a rotation ratio of the first rotating body, and
attributes are assigned to the photodetectors every predetermined phase angle.

2. The encoder according to claim 1, wherein the to-be-detected light which passed through the slit crosses the alignment line at least at two points apart from each other.

3. The encoder according to claim 1, wherein the photodetectors are aligned in a staggered pattern along the alignment line.

4. A photodetecting device for an encoder comprising:
a first scale and a second scale, wherein each of the first scale and the second scale has a plurality of photodetectors aligned along an annular alignment line; and
an output part which outputs output signals based on light intensities of to-be-detected light, the light made incident on the photodetectors of the first scale and the second scale, wherein
attributes are assigned to the photodetectors every predetermined phase angle.

5. The photodetecting device for the encoder according to claim 4, wherein
the output part includes a shift register which sequentially outputs the output signals from the photodetectors, and
the shift register is arranged at the inner side of the alignment line.

6. The photodetecting device for the encoder according to claim 4, wherein the photodetectors are aligned in a staggered pattern along the alignment line.
